(19) United States
(12) Patent Application Publication
(10) Pub. No.: US 2024/0313321 A1
(43) Pub. Date: Sep. 19, 2024

(54) BATTERY COMPARTMENT ADAPTER ASSEMBLY

(71) Applicants: Noreek Davitian, Fort Lauderdale, FL (US); Pietro Roccisano, Coral Springs, FL (US)

(72) Inventors: Noreek Davitian, Fort Lauderdale, FL (US); Pietro Roccisano, Coral Springs, FL (US)

(21) Appl. No.: 18/606,812

(22) Filed: Mar. 15, 2024

Related U.S. Application Data
(60) Provisional application No. 63/452,744, filed on Mar. 17, 2023.

(51) Int. Cl. H01M 50/247; H01M 50/202; H01M 50/271; H01M 50/296

(52) U.S. Cl. CPC H01M 50/247; H01M 50/202; H01M 50/271; H01M 50/296; H01M 2220/30

(57) ABSTRACT

A battery compartment adapter assembly which includes a battery holder member having an open end and an internal chamber sized to receive and contain a removable battery and an adapter member sized to be secured over the open end of the battery holder member and having two isolated conductive elements to provide a contact for both a negative and positive terminal on the removable battery. The adapter member is additionally configured to be securely coupled to a battery compartment of a discrete electrical device. In this regard, when a suitable battery is placed in the battery holder member, the adapter member is placed on battery holder member, and the adapter member attached to the battery compartment of a target electrical device, the battery compartment adapter assembly allows electrical power from the contained battery to be delivered to the target electrical device.

### CROSS REFERENCE TO RELATED APPLICATIONS

This application claims the benefit of and incorporates by reference co-pending U.S. provisional patent application Ser. No. 63/452,744 filed Mar. 17, 2023.

### BACKGROUND OF THE INVENTION

### Field of the Invention

The present disclosure relates generally to onboard power supplies for portable electronic devices, and, more particularly, to a removable adapter assembly for a battery compartment in a powered dot optic device which enables alternate sized batteries to engage with the existing battery compartment and supply power to the dot optic device.

### Description of the Prior Art

The use and design of electric batteries to supply power to an electrical device is well established. Batteries are commonly used to provide a source of electrical direct current (“DC”) power which is portable, thereby enabling the production and use of a virtually endless array of devices which require electricity but are portable. The use of batteries with so many types of electrical devices has resulted in the proliferation of batteries in many different size units. In this regard, it is common for such portable electrical devices to include some form of battery compartment within their construction; with this battery compartment having a physical size and shape conforming to the physical dimensions of the specific battery type which the portable device is designed to utilize. Such battery compartment designs often include removable battery compartment caps which enable the battery or batteries contained within the compartment to be removed and replaced with new or recharged batteries.

A problem which still exists, however, is that having a device's battery compartment conforming to the physical dimensions of a specific battery type places a substantial limitation upon the number of different battery types which may be capable of use with any given piece of equipment. This means that in view of the great diversity and lack of standardization of battery shapes and sizes, electrical devices may be limited by size and/or by dimensions as far as the types of batteries they can use, even though a great many batteries might otherwise satisfy the voltage and current requirements of the device.

This problem relating to size based limited of battery interchangeability may be exemplified when dealing with equipment which employs special purpose batteries which are designed solely for use with such equipment. Although such special purpose batteries may be capable of use over extended time intervals, it sometimes happens that the such a special purpose battery becomes dissipated at an inconvenient time or place, when a replacement is not available. Under such conditions, it would be desirable to be able to substitute other types of commonly available long-life batteries for the special purpose battery which has become dissipated so that the equipment can still be used.

Thus, there remains a need for an adapter assembly which can be coupled with a target battery compartment of a device so as to enable a battery sized such that it cannot fit in said compartment, but otherwise able to satisfy the voltage and current requirements, to be used with the device. It would be additionally desirable for such a battery compartment adapter assembly to be structured to mechanically and electrically engage the target battery compartment in place of an existing closure mechanism for the target battery compartment. Even further, it would be desirable for such a battery compartment adapter assembly to provide an extended housing suitable to receive batteries capable of having a longer life than the battery type that can fit into the target battery compartment.

### SUMMARY OF THE INVENTION

The present disclosure provides for a battery compartment adapter (or “adaptor”) assembly, comprising: a battery holder member having a housing body having an opening and an internal chamber sized to receive and contain a removable supplying battery that is capable of delivering electrical power; an adapter member having a first portion sized and configured to engage and couple with the battery holder member in a manner which covers the opening and having a second portion configured to engage and couple with a battery compartment of a discrete target electrical device; wherein the adapter member includes at least two isolated conductive elements; and wherein when the supplying battery is disposed in the internal chamber with the adapter member coupled with the battery holder member and in contact with the supplying battery, and the adapter member is coupled with a target battery compartment of the target electrical device, the battery compartment adapter assembly is operative to provide electrical power from the supplying battery to the target electrical device through the at least two isolated conductive elements and the target battery compartment. In this regard, the present disclosure provides a removable, retrofitting battery compartment adapter assembly that extends and modifies the battery compartment of a powered dot optic device.

It is an object of the present disclosure to provide a battery compartment adapter assembly which can be coupled with a target battery compartment of a device so as to enable a battery sized such that it cannot fit in said compartment, but is otherwise able to satisfy the voltage and current requirements, to be used with the device.

It is an additional object of the present disclosure to provide a battery compartment adapter assembly which is structured to mechanically and electrically engage the target battery compartment in place of an existing closure mechanism for the target battery compartment.

It is an additional object of the present disclosure to provide a battery compartment adapter assembly which provides an extended housing suitable to receive batteries capable of having a longer life than the battery type that can fit into the target battery compartment.

### BRIEF DESCRIPTION OF THE DRAWINGS

FIG. 1 is a partial perspective view of a battery compartment and closure mechanism of a powdered dot optic device built in accordance with the prior art.

FIG. 2 is a perspective view of a battery compartment adapter assembly built in accordance with the present disclosure.

FIG. 3 is a perspective view of a cross section of a battery compartment adapter assembly built in accordance with the present disclosure.

FIG. 4 is a perspective view of a cross section of a battery compartment adapter assembly built in accordance with the present disclosure.

FIG. 5 is a partial perspective view of a battery compartment adapter assembly built in accordance with the present disclosure, shown coupled with a battery compartment of a powdered dot optic device.

### DETAILED DESCRIPTION OF THE INVENTION

Described herein is a battery compartment adapter assembly which includes an adapter member and a battery holder member and is operative to supply electrical power to a battery compartment of a discrete device from a removable battery that is contained in battery compartment adapter assembly. The battery holder member includes an elongated cylindrical housing having an internal chamber sized to receive and contain a removable battery and open end. The adapter member includes two isolated conductive elements, so as to enable the adapter member to provide a contact for both a negative and positive terminal on a removable battery, and is sized to be secured over and enclose the open end of the battery holder member. The open end of the battery holder member is configured to receive and engage the adapter member through a holder threaded portion, and the adapter member is configured to engage, and be securely coupled to, the open end of the battery holder member through a housing engagement portion. The adapter member is furthermore configured to engage and be securely coupled to a battery compartment of a discrete device through a compartment engagement portion. In this regard, when a suitable battery is placed in the battery holder member, contained in the internal chamber with the adapter member in place over the open end of the battery holder member, the battery compartment adapter assembly allows electrical power from the contained battery to be delivered through the adapter member to the battery compartment of a suitable target device.

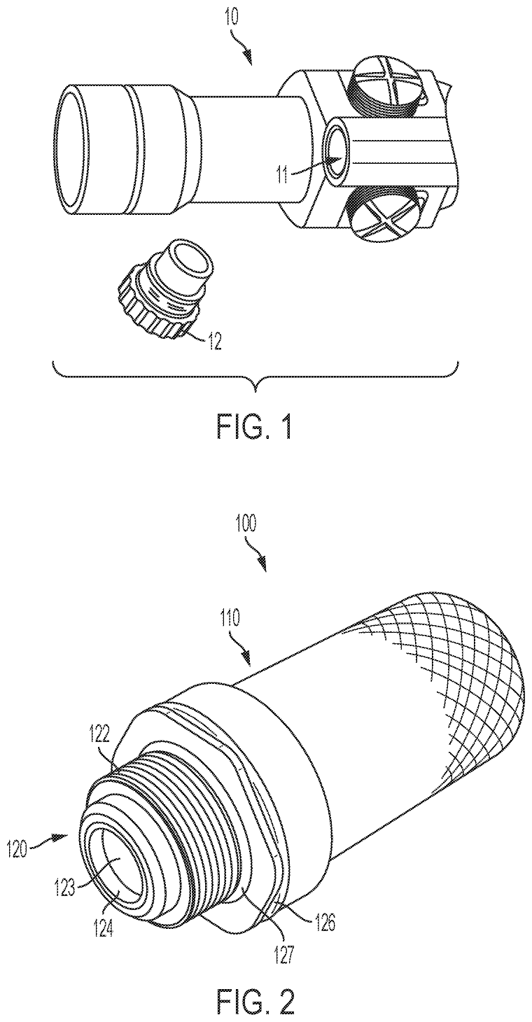

Referring now to the drawings and, in particular, FIG. 1, a powered dot optic device 10 with which a battery compartment adapter assembly in accordance with the present disclosure may be used is shown. The dot optic device 10 may be a device made by Aimpoint AB, such as an Aimpoint Comp M2, M3, or Pro. In any event, this dot optic device 10 incorporates a horizontally oriented battery compartment 11 having an open end and a closure mechanism which is defined by a removable battery compartment cap 12, with the battery compartment cap 12 sized to fit over the open end of the battery compartment 11. The battery compartment 11 and the battery compartment cap 12 include a corresponding threaded surfaces which allow the battery compartment cap 12 to screw on to the battery compartment 11 and thereby be secured thereto. The battery compartment 11 as shown may be constructed to be loaded with a lithium 3V ⅓N battery, which may not be as readily available as other 3V batteries.

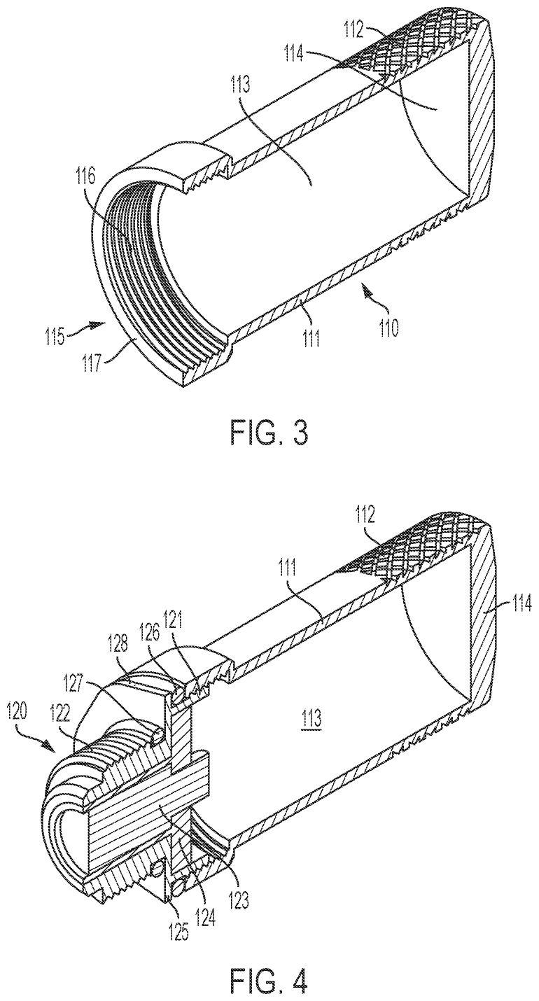

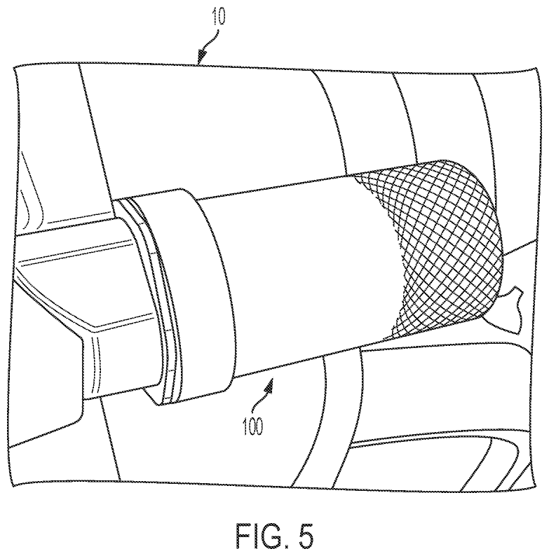

Referring now to FIGS. 1, 2, 3, 4, and 5, a battery compartment adapter assembly 100 may operate to supply electrical power to a battery compartment of a powered dot optic device 10 from a battery that is contained in battery compartment adapter assembly 100. The battery compartment adapter assembly 100 may be defined by a battery holder member 110 and a rigid adapter member 120. The battery holder member 110 includes an elongated cylindrical housing body 111 having an exterior surface 112, an internal chamber 113 sized to receive and contain a removable battery (not shown), a closed end 114, and open end 115.

The exterior surface 112 may include a knurled area which operates to increase surface friction and thereby prevent slippage and allow for a better grip. The internal chamber 113 in embodiments of the battery holder member 110 may be sized to receive and hold a CR123A style 3V lithium battery. It is contemplated that relative to a lithium 3V ⅓N battery, a CR123A style 3V lithium battery may be much easier to find, be more economical, have a longer shelf life, be more temperature stabile, and have a much higher lifespan. A portion of an interior surface of the housing body 111 which is adjacent to the open end 115 may include a holder threaded portion 116. As discussed below, this holder threaded portion 116 corresponds to, and is structured to engage with, a housing engagement portion on the adapter member 120. Furthermore, the terminal edge 117 of the open end 115 includes a chamfer which contacts the adapter member 120 so as to improve the ability of the terminal edge 117 to retain and provide a seal with a housing gasket thereon.

The adapter member 120 includes a proximal threaded portion 121, a distal threaded portion 122, a plunger 123 and a plunger isolator 124. The proximal threaded portion 121 forms the housing engagement portion and includes a threaded surface which corresponds to, and is structured to engage with, the holder threaded portion 116 on the housing body 111. The distal threaded portion 122 forms a compartment engagement portion and includes a threaded surface which corresponds to, and is structured to engage with, a threaded surface on to a battery compartment to which the battery compartment adapter assembly 100 may connect. The proximal threaded portion 121 and distal threaded portion 122 are formed of a conductive material and each are connected to one another by a conductive radial portion 125, together forming a first conductive element. The first conductive element allows the housing engagement portion and compartment engagement portion to conduct a first polarity of a battery enclosed in the battery compartment adapter assembly 100 to circuitry in the dot optic device 10 in addition to serving a mechanical connector.

The plunger 123 and the plunger isolator 124 are disposed in, and extend through, a concentric shaft in the middle of the adapter member 120 which is surrounded by the distal threaded portion 122 and radial portion 125. The plunger 123 extends through almost the entire length of the adapter member 120, from adjacent to one longitudinally end to adjacent to the other longitudinal end, and is constructed of conductive material so as to conduct a second polarity of a battery enclosed in the battery compartment adapter assembly 100 to circuitry in the dot optic device 10 and define a second conductive element. The plunger isolator 124 is positioned to separate the plunger 123 from the proximal threaded portion 121, distal threaded portion 122, and radial portion 125, and thus isolates the positive and negative conductive elements of the battery. The plunger isolator 124 also may operate to provide a surface on which the battery may rest upon when sealed in the battery compartment adapter assembly 100.

The adapter member 120 may also include a proximal O-ring 126 forming a housing gasket which operates to seal the corresponding mating surfaces of the battery holder member 110 and the adapter member 120 and a distal O-ring 127 forming a compartment gasket which operates to seal the mating surface of the adapter member 120 to the surface of the battery compartment 11 of the dot optic device 10. Furthermore, the adapter member 120 may include an exterior surface having perpendicular wrench flats 128 to allow the adapter member 120 to be securely tightened to the dot optic device 10.

It is appreciated that a battery compartment adapter assembly in accordance with the present disclosure may provide an economical, easy to utilize battery adapter which permits the replacement of a low-life standard cylindrical battery cell with a standard cylindrical battery cell having a long-life type battery, and permit the easy replacement of shorter life type batteries and the like with a longer life source of electrical power.

It is additionally appreciated that a battery compartment adapter assembly in accordance with the present disclosure may provide an improved device for supplying electrical power to low power long life environments and provide an effective alternative to power cells in such low power long life environments.

It is additionally appreciated that a battery compartment adapter assembly in accordance with the present disclosure may operate to adapt batteries of one size and shape to applications calling for batteries of substantially different physical size and shape.

It is additionally appreciated that a battery compartment adapter assembly in accordance with the present disclosure may enable converting equipment designed for use with one type of battery to interchangeable use with other batteries having different physical dimensions but proper electrical characteristics.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A battery compartment adapter assembly, comprising:
a battery holder member having a housing body having an opening and an internal chamber sized to receive and contain a removable supplying battery that is capable of delivering electrical power;
an adapter member having a first portion sized and configured to engage and couple with the battery holder member in a manner which covers the opening and having a second portion configured to engage and couple with a battery compartment of a discrete target electrical device;
wherein the adapter member includes at least two isolated conductive elements; and
wherein when the supplying battery is disposed in the internal chamber with the adapter member coupled with the battery holder member and in contact with the supplying battery, and the adapter member is coupled with a target battery compartment of the target electrical device, the battery compartment adapter assembly is operative to provide electrical power from the supplying battery to the target electrical device through the at least two isolated conductive elements and the target battery compartment.

2. The battery compartment adapter assembly of claim 1, wherein the first portion is formed at least in part by a first aspect of a first conductive element among the at least two isolated conductive elements.

3. The battery compartment adapter assembly of claim 1, wherein the second portion is formed at least in part by a second aspect of a first conductive element among the at least two isolated conductive elements.

4. The battery compartment adapter assembly of claim 3, wherein the first portion is formed at least in part by a first aspect of the first conductive element.

5. The battery compartment adapter assembly of claim 4, wherein a second conductive element among the at least two isolated conductive elements is surrounded by the first conductive element.

6. The battery compartment adapter assembly of claim 5, wherein the adapter member includes an isolating body which is positioned to physically and electrically isolate the first conductive element and the second conductive element.

7. The battery compartment adapter assembly of claim 1, wherein the adapter member additionally includes a housing gasket adjacent to the first portion and a compartment gasket adjacent to the second portion.

8. A battery compartment adapter assembly, comprising:
a battery holder member having a housing body having an opening and an internal chamber sized to receive and contain a removable supplying battery that is capable of delivering electrical power;
an adapter member having a first portion sized and configured to engage and couple with the battery holder member in a manner which covers the opening and having a second portion configured to engage and couple with a battery compartment of a discrete target electrical device;
wherein the adapter member includes a first conductive element and a second conductive element; and
wherein when the supplying battery is disposed in the internal chamber with the adapter member coupled with the battery holder member and in contact with the supplying battery, and the adapter member is coupled with a target battery compartment of the target electrical device, the battery compartment adapter assembly is operative to provide electrical power from the supplying battery to the target electrical device through the first conductive element, the second conductive element, and the target battery compartment.

9. The battery compartment adapter assembly of claim 8, wherein the first portion is formed at least in part by a first aspect of the first conductive element.

10. The battery compartment adapter assembly of claim 8, wherein the second portion is formed at least in part by a second aspect of the first conductive element.

11. The battery compartment adapter assembly of claim 10, wherein the first portion is formed at least in part by the first aspect of the first conductive element.

12. The battery compartment adapter assembly of claim 11, wherein the adapter member includes a concentric shaft which is surrounded by the first conductive element.

13. The battery compartment adapter assembly of claim 12, wherein at least a portion of the second conductive element is disposed in the concentric shaft.

14. The battery compartment adapter assembly of claim 13, additionally comprising a isolating body, wherein at least a portion of the isolating body is disposed in the concentric shaft and the isolating body is positioned to physically and electrically isolate the first conductive element and the second conductive element.

15. The battery compartment adapter assembly of claim 11, wherein the second conductive element is surrounded by, but physically and electrically isolated from, the first conductive element.

16. The battery compartment adapter assembly of claim 8, wherein the adapter member additionally includes a housing gasket adjacent to the first portion and a compartment gasket adjacent to the second portion.

17. A battery compartment adapter assembly, comprising:
a battery holder member having a housing body having an opening and an internal chamber sized to receive and contain a removable supplying battery that is capable of delivering electrical power;
an adapter member having a first portion sized and configured to engage and couple with the battery holder member in a manner which covers the opening and having a second portion configured to engage and couple with a battery compartment of a discrete target electrical device;
wherein the adapter member includes a first conductive element and a second conductive element;
wherein the second conductive element is surrounded by, but physically and electrically isolated from, the first conductive element; and
wherein when the supplying battery is disposed in the internal chamber with the adapter member coupled with the battery holder member and in contact with the supplying battery, and the adapter member is coupled with a target battery compartment of the target electrical device, the battery compartment adapter assembly is operative to provide electrical power from the supplying battery to the target electrical device through the first conductive element, the second conductive element, and the target battery compartment.

18. The battery compartment adapter assembly of claim 17, wherein the first portion is formed at least in part by a first aspect of the first conductive element and the second portion is formed at least in part by a second aspect of the first conductive element.

19. The battery compartment adapter assembly of claim 17, wherein the adapter member additionally includes a housing gasket adjacent to the first portion and a compartment gasket adjacent to the second portion.

20. The battery compartment adapter assembly of claim 17, wherein the housing body has an external surface which includes a knurled area.
